(19) United States
(12) Patent Application Publication
(10) Pub. No.: US 2008/0117044 A1
(43) Pub. Date: May 22, 2008

(54) Passive Magnetic Detection System for Security Screening

(76) Inventor: Andrew D Hibbs, La Jolla, CA (US)

Correspondence Address: DIEDERIKS & WHITELAW, PLC, 12471 DILLINGHAM SQUARE, #301, WOODBRIDGE, VA, 22192, US

(21) Appl. No.: 11/662,935

(22) PCT Filed: Sep. 22, 2005
(86) PCT No.: PCT/US05/34032

§ 371 Date: Mar. 16, 2007

Related U.S. Application Data
(60) Provisional application No. 60/611,846, filed on Sep. 22, 2004.

(51) Int. Cl. G08B 13/00

(52) U.S. Cl. 340/568.1

(57) ABSTRACT

A magnetic detection system to be used by security personnel for the purpose of discovering hidden or otherwise concealed objects being brought into or taken out of a defined or screened area employs magnetic induction sensors and, more particularly, a support structure that holds one or more sensors in a defined orientation relative to an object to be screened. The system can also include auxiliary components, such as a cancellation unit for nullifying an interfering environmental field, a camera for taking photographs or video of a subject, and presence sensors for use in verifying or signaling the existence of a subject to be screened.

### CROSS-REFERENCE TO RELATED APPLICATIONS

The present invention claims the benefit of U.S. Provisional Patent Application Ser. No. 60/611,846 entitled “Passive Magnetic Detection Gateway for Security Screening” filed Sep. 22, 2004, the entire contents of which are incorporated herein by reference.

### BACKGROUND OF THE INVENTION

1. Field of the Invention

The present invention relates generally to a security detection system and, more particularly, to a passive apparatus and method for detecting unauthorized items, specifically items made from ferrous metals, that are passed through a screening system.

2. Discussion of the Prior Art

Many types of screening systems for the detection of concealed objects are known and used in a variety of security situations. The majority of these systems are used to detect unauthorized objects that can be used as weapons and are being concealed by a person attempting to gain access to some type of facility, e.g. an airport, a school, or a public forum like a sports stadium. A large percentage of these security devices are based on the use of magnetic sensors to detect metal present in the unauthorized objects.

Most magnetic metal detectors rely on an applied magnetic field to induce electric currents in metallic objects, and then detect the magnetic field produced by this current. These systems take advantage of their control of the applied field to generate a signal sufficient to discriminate the measured signals from environmental noise, and to detect the metallic objects.

Passive magnetic-based screening systems do not utilize an applied field and must use detection circuitry with very high sensitivity. In addition, measures must be taken to isolate the magnetic field detectors from environmental interference and the effect of vibration in the Earth's magnetic field. The standard method to achieve such noise isolation is to produce a magnetic gradiometer by subtracting the output of two calibrated and balanced sensors. The sensors must be rigidly connected so that they move as a common unit and situated such that one couples to the signal of interest more strongly than the other. The latter requirement results in a system structure much larger than it otherwise would need to be.

The magnetic sensors that have been used to date in prior art passive systems are DC coupled. This means they respond directly to the Earth's static magnetic field and are accordingly strongly affected by low-frequency motion in that field. The low-frequency motion can be caused by people walking nearby, the operation of vehicles and machinery, and the like, at least some of which is very likely to be present in practical security screening scenarios. In addition, practical, affordable prior art DC-coupled magnetic sensors are limited to a sensitivity of approximately 10 pT/Hz^{1/2} at the frequencies of interest for passive security screening.

Therefore the construction and operation of known magnetic-based screening systems provide for limited accuracy, sensitivity and field of use. To this end, there exists a need in the art for an improved security detection system which overcomes at least the deficiencies set forth above.

### SUMMARY OF THE INVENTION

The passive magnetic detection gateway for security screening in accordance with the invention utilizes a set of magnetic sensors mounted on or in a framework or other support structure. In connection with the invention, a preferable type of magnetic sensor is a magnetic induction sensor. This type of sensor is AC coupled and so does not suffer from the problem of coupling to very low frequency signals. Also, it can be easily configured so that it does not respond to signals above a certain defined frequency. The induction sensor has the further advantage of having the highest sensitivity (<1 pT/Hz^{1/2}) of room temperature magnetic field sensors. Until recently, conventional magnetic induction sensors were simply too large and too expensive to be used in most screening applications. However, magnetic induction sensors have now been developed which are small enough to enable multiple units to be built into common structures, such as a gateway of a walk-through screening device, while retaining sensitivity of order 1 pT/Hz^{1/2}. Preferably, the sensors are mounted vertically, but can also be mounted along or normal to the direction of transit. The sensors can be placed at specific, predetermined positions in the support structure to advantageously give an indication of the actual location of the detected item on the body of a subject or object being screened.

The induction sensor employed in connection with the invention utilizes a preamplifier that responds directly to the magnetic field at the sensor, rather than responding to the rate of change of magnetic field, as do conventional induction sensors. This new approach is based on reading out the electrical current signal from the induction sensor winding and results in a smaller sensor volume for a given sensitivity than prior art designs, which are optimized to read the coil voltage.

In addition to the sensors in the support structure, one or more additional sensor(s), positioned relatively remote from the sensing region, can be used to measure existing environmental signals and generate an electrical current signal of opposite sign that is passed to coils wound around sensors in the structure of the same orientation. This current produces a magnetic field in the main sensors with the purpose of canceling the environmental magnetic signal. By using this analog cancellation method, the maximum amplitude of the time-varying magnetic signal that must be collected by subsequent electronics is significantly reduced. In addition, the amplitude of general variations in the background signal is reduced in the recorded signal. This rejection of the background fluctuations greatly reduces the false alarm rate of the overall system when screening for small objects. In particularly high noise environments, such as operation outdoors, it may be necessary to add active cancellation of environmental noise through software. In this case, the output from the remote sensor(s) can be digitized and then subtracted by an appropriate algorithm running on a computer.

A magnetic field-based security screening system constructed in accordance with the invention has the benefit of not emitting any active probing fields, and has high tolerance to environmental electromagnetic noise and noise due to vibration-induced motion of the support structure. Owing to the use of magnetic induction sensors rather than magnetic gradiometers, the width of the opening afforded by the support structure can be increased considerably over that of prior systems and smaller objects can be detected.

The small size and high performance of the sensors makes it possible to employ additional sensors to cancel environmental noise. In addition, induction sensors have the benefit that, owing to their simple high-permeability cores, it is relatively simple to null the pickup of external noise by feeding an active signal to a small coil coupled to them. Such active nulling allows cancellation of high amplitude interference such as from power lines that typically limits the dynamic range of magnetic sensors, enabling the full sensitivity of the induction sensors to be exploited. In conjunction, or separately, software-based adaptive nulling methods can be employed with induction sensors to produce effective detection sensitivities well below the environmental magnetic field level.

Thus, the application of a new magnetic induction sensor system makes possible the construction of an improved passive screening device for ferrous objects. The improved sensitivity allows a reduction in the number of sensors needed and, since the more sensitive sensors do not need to be in such close proximity to an object of interest as with other systems, a wider, more open screening arrangement can be established. The use of noise cancellation methods enables the fall sensitivity of an induction sensor to be used without constructing gradiometer sensing units, while allowing the detection of very small objects in a practical environment.

Additional features of the invention include adding a presence sensor, such as a light beam, pressure pad or the like, at the support structure to detect the presence of a subject, i.e., person or object to be screened. In addition, a video or still camera can be used to photograph subjects being screened. Furthermore, magnetic or other sensors can be placed adjacent the support structure to sense anyone trying to pass a detectable item around the structure. In general, the sensor system of the invention could be employed in any structure around which people must normally pass such that the detection system operates inconspicuously to detect objects of interest. In any event, additional objects, features and advantages of the present invention will become more fully apparent from the following description of preferred embodiments shown in the figures wherein like reference numerals refer to corresponding parts in the several views.

### BRIEF DESCRIPTION OF THE DRAWINGS

FIG. 1 is a perspective view of a security gateway incorporating a passive magnetic detection system constructed in accordance with the present invention;

FIG. 2 is a perspective view of a compact magnetic induction sensor employed in the passive magnetic detection system of FIG. 1;

FIG. 3 is a block diagram of a control arrangement employed with the passive magnetic detection system of the invention;

FIG. 4A is a schematic representation of a circuit employed with the compact magnetic induction sensor of FIG. 2;

FIG. 4B is a schematic representation of another circuit employed with the compact magnetic induction sensor of FIG. 2;

FIG. 4C is a schematic representation of a further circuit employed with the compact magnetic induction sensor of FIG. 2;

FIG. 5 is a graphical representation of the response and sensitivity of the magnetic induction sensor detection system; and

FIG. 6 is a schematic representation of an active noise cancellation assembly employed in connection with the magnetic induction sensor detection system; and

FIG. 7 is a perspective view of another security gateway arrangement incorporating the passive magnetic detection system of the invention.

### DETAILED DESCRIPTION OF THE INVENTION

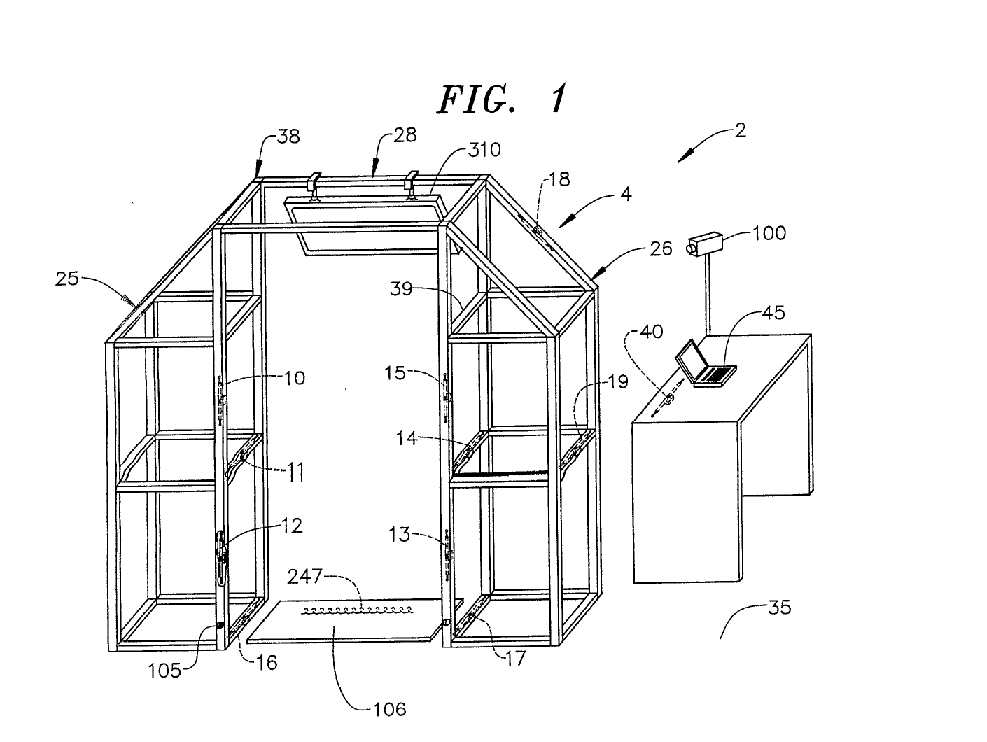

A passive magnetic detection system 2 for detecting ferrous objects being carried by a subject, i.e. a person or container, such as a box or crate, into a secured area is shown in FIG. 1. Detection system 2 comprises of a rigid structure or gateway 4 and a number of magnetic induction sensors 10-19. As shown, gateway 4 is shown to include laterally spaced pillar units 25 and 26, as well as an interconnecting overhead unit 28. In a preferred embodiment of the invention, gateway 4 is intended to be set up on a flat surface 35, either outside on the ground or inside on a floor. In the embodiment shown, gateway 4 constitutes the type of security screening structure through which people must pass in various places, such as airports, schools, government buildings and the like. To this end, pillar units 25 and 26 are spaced far enough apart so that an average person can easily walk through the center of gateway 4 and below overhead unit 28. Actually, based on the structure and operation of system 2, pillar units 25 and 26 can be spaced farther apart than typically found in the prior art. In any case, gateway 4 includes a frame 38 which can be formed in many ways and of various materials. In the most preferred embodiment, frame 38 is composed of hollow tubes, such as that indicated at 39, that are large enough to contain a respective sensor 10-19.

Although the embodiment shown in FIG. 1 includes overhead unit 28 interconnecting pillar units 25 and 26, as will become more fully evident below, a connection between pillar units 25 and 26 is not required and, in fact, gateway 4 can take various forms, including a single pillar or a lengthened gateway or tunnel with additional sensors along the direction of transit or in a horizontal plane perpendicular to this direction if appropriate structural members are provided. System 2 might be disguised by building sensors 10-19 into an existing structure, such as an entry kiosk or into an architectural feature like a column or a planter. Sensors 10-19 could also be built into a crowd control structure, like a turnstile or stanchion used with ropes or chains to organize a crowd of people into individual lanes. As will be discussed further below with respect to these embodiments, objects can pass on any side of gateway 4 and still be detected.

In the most preferred embodiment, sensors 10, 12, 13 and 15 are attached to gateway 4 in a vertical orientation and constitute primary sensors. Since it is reasonable to assume that there is an equal probability that unauthorized items could be located in any part of gateway 4, at least sensors 10, 12, 13 and 15 are preferably, equally provided on each side of gateway 4. The spacing, both horizontally and vertically, of sensors 10-19 not only enables the detection of ferrous items (not shown) which are directed through gateway 4, either carried by a person or located in a box, bag, crate or the like, but advantageously identifies the location of a detected item relative to the subject (not shown) possessing the item. More specifically, since the magnetic signal produced by a ferrous item decreases with the distance from the item, signals from the various sensors 10-19 can be processed to actually indicate the presence and positioning of the item relative to the subject being screened. In addition, the signals from sensors 10, 12, 13 and 15 can be averaged to increase the spatial resolution of system 2. It should be obvious to those skilled in the art that the more sensors used, the more accurate the localizing accuracy will be. At this point, it should be understood that the spacing and orientation of the various sensors can vary from that shown, with at least two of the sensors being preferably used in order to establish the presence and positioning of the item relative to the subject being screened as will become more fully evident below.

Although not shown for the sake of simplicity, additional sensors could be positioned at the rear of gateway 4 such that sensors 10, 12, 13 and 15, along with the additional rear sensors, make independent measurements of the subject as it passes through gateway 4. This arrangement provides improved detection performance by allowing two independent measurements of a given subject. In addition, as the time variation of signals as a person or container carrying an unauthorized object passes through gateway 4 depends in part on the size of the item and the orientation of the sensors relative to the line of travel of the subject, it is possible to estimate the size of the item, in particular to distinguish a small, highly magnetic object from a physically larger object, such as a gun. Analysis of the time variation also provides a method to determine whether a concealed object is at the front or the back of the person carrying the item or the container in which the item is located.

In the preferred embodiment shown, additional sensors 11, 14, 18 and 19 are placed on gateway 4 in other orientations, e.g., horizontal, skewed, etc., as compared to the primary sensors. These additional sensors 11, 14, 18 and 19 are designed to provide reference signals used to reduce the detection of spurious signals by primary sensors 10, 12, 13 and 15. For example, sensor 18 located on an edge of gateway 4 furthest away from the likely location of the item to be detected is employed to reduce the detection of environmental background magnetic fields. In a similar fashion, one or more sensors 40 could be mounted adjacent gateway 4 near a local interfering source, like computer 45 or a conveyer belt motor (not shown). Similarly, a sensor (not shown) could also be located near the position where a security guard might stand carrying a service revolver. In a situation where multiple systems are in use simultaneously, one or more additional sensors are preferably used to reject signals from people walking through neighboring structures.

In addition to the above, sensors 16 and 17 are strategically placed on gateway 4 near floor 35 for the purpose of detecting shoe shanks made from ferrous metals. In addition to sensors 18 and 19, other sensors (not shown) could be mounted on the outside of gateway 4, preferably in a vertical orientation, to detect unauthorized items that may be passed around gateway 4 in an attempt to escape detection. In any case, it should be readily apparent that the number and positioning of the various sensors can be readily altered in accordance with the invention, with at least a first set of sensors representing primary sensors designed to detect the existence and vertical positioning of ferrous items, a second set of sensors being employed to detect and counter the effects of background and other adjacent magnetic fields, and a third set of sensors being designed to detect magnetic fields at specific adjacent locations.

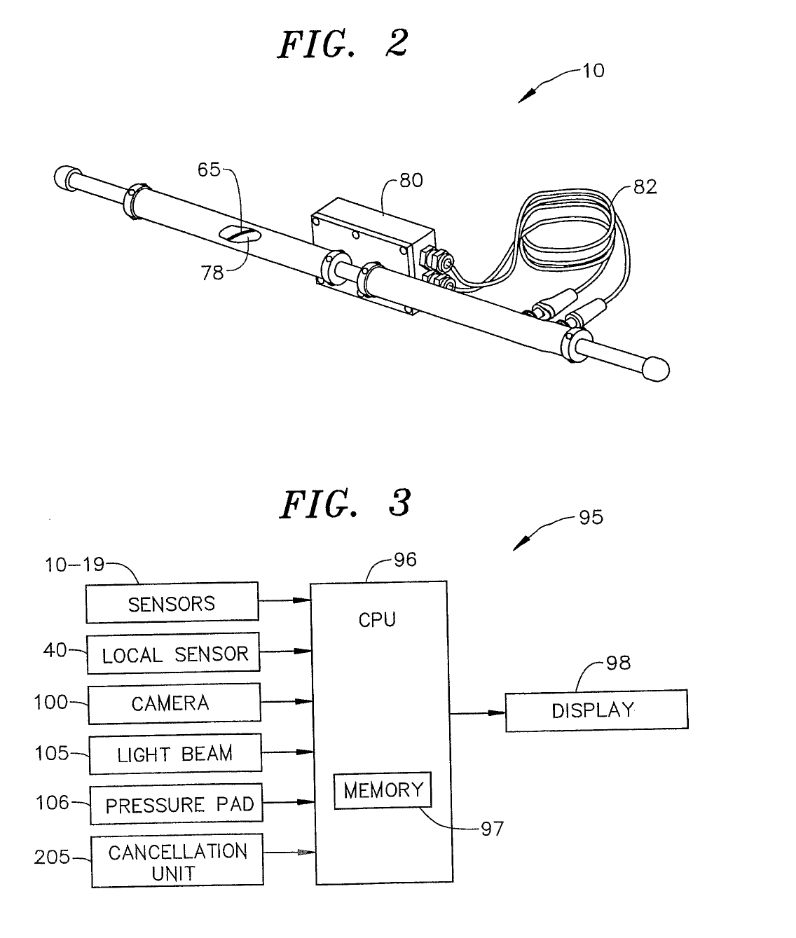

Reference will now be made to FIG. 2 in describing a preferred construction for magnetic induction sensor 10 employed in passive magnetic detection system 2 and it is to be understood that sensors 11-19 and 40 are correspondingly constructed. As shown, sensor 10 includes a coil 65, preferably constituted by copper wire, wrapped around a high permeability core 78. In addition, an amplifier unit 80 is provided in close proximity to coil 65 and adapted to be linked through wiring 82 to a controller and a power source (not shown) as discussed further below. In general, the operation of sensors 10-19 is based on the principle that ferrous materials are sources of static magnetic fields. Movement of the ferrous material with respect to coil 65 will cause a voltage, known as the induced emf, to be generated in coil 65 according to Faraday's law. The induced emf causes a current to flow in coil 65. Sensor 10 utilizes amplifier unit 80 that responds directly to the magnetic field at sensor 10, rather than responding to the rate of change of magnetic field, as do conventional induction sensors. This enhanced approach is based on reading out the electrical current signal from the winding of coil 65 and results in sensor 10 being smaller in volume for a given sensitivity than prior art designs, which are optimized to read coil voltage. The use of this particular induction sensor technology enables a significantly more compact detection arrangement for system 2.

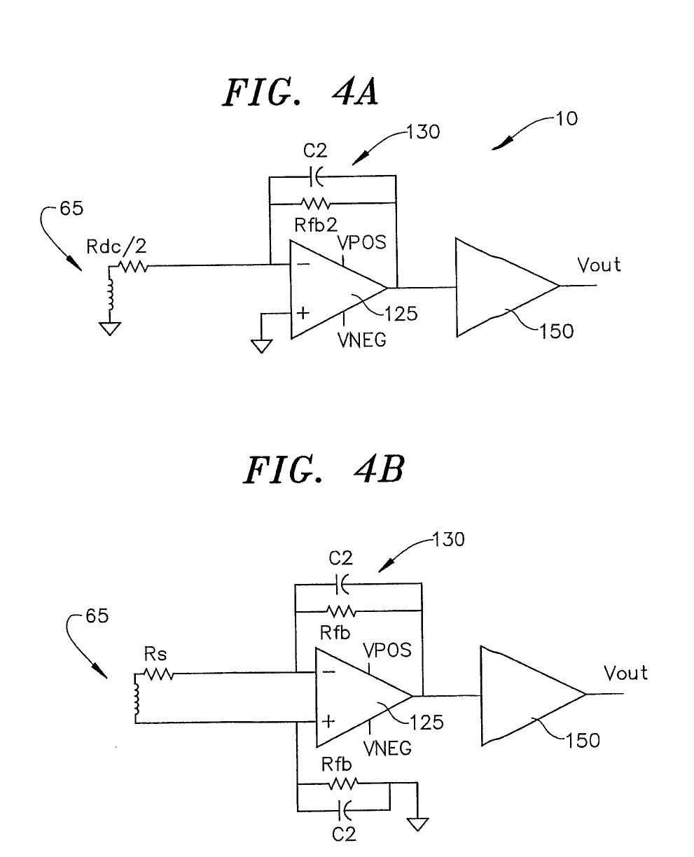

With reference to FIG. 3, system 2 includes a computerized data acquisition assembly 95 including a CPU 96 for the purpose of measuring the response of each of sensors 10-19, analyzing the sensor data to determine if an unauthorized item is present, storing processed information in memory 97 and displaying the results of the analysis, as well as possibly the raw data, through a display unit 98. As also depicted in this figure, CPU 96 also preferably receives inputs from other screening instruments. In particular, photo and/or video data is gathered and transmitted from a camera 100 (also see FIG. 1). Further inputs are received from one or more presence sensors, such as a light beam sensor 105, pressure pad 106 or the like, provided at gateway 4 to detect and verify the actual presence of a subject, i.e., person or object to be screened.

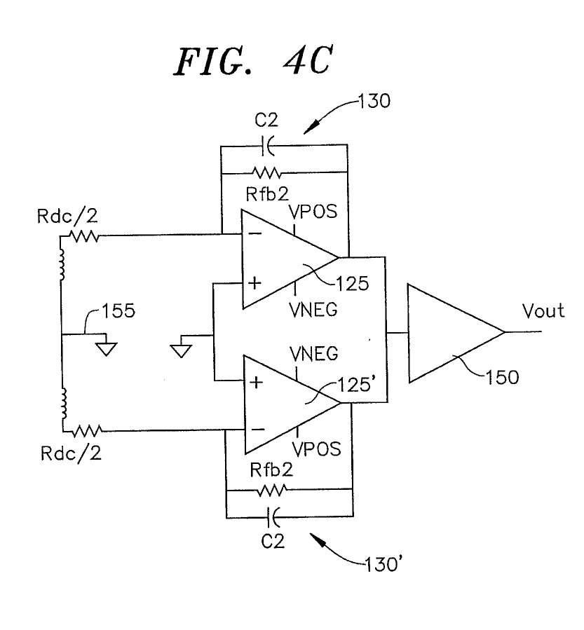

The essential operation of each of magnetic sensors 10-19 including coil 65 and amplifier unit 80 is schematically illustrated with reference to sensor 10 in FIG. 4A. As shown, coil 65 drives a pre-amplifier 125 with a low input impedance (Rᵢ). The voltage at the input to the pre-amplifier 125 is:

$${V}_{a} = \frac{{R}_{i}}{{R}_{i} + {R}_{s}} \frac{jω {BA}_{eff}}{1 + jω \frac{L}{{R}_{i} + {R}_{s}}}$$

Here ω is the radial frequency, j is the square root of −1, Rᵢ is the amplifier input impedance, Rₛ is the coil series resistance, A_{eff} is the effective area of the sensor, L is the inductance of the coil, and B is the component of the field parallel to the axis of the coil. Above a frequency given by

$$f = \frac{( {R}_{i} + {R}_{s} )}{2 π L}$$

the response is flat, with the voltage at the input to pre-amplifier 125 being given by:

$${V}_{a} = \frac{{R}_{i} {BA}_{eff}}{L}$$

Thus sensor 10 produces a signal proportional to the ambient B-field and not to its time derivative. Below this characteristic frequency, the response is like the conventional induction sensor, with the response linear in frequency.

$${V}_{a} = jω {BA}_{eff} \frac{{R}_{i}}{{R}_{i} + {R}_{s}}$$

To further emphasize the novel nature of sensor 10, the analysis above can be repeated in terms of the current produced by sensing coil 65. As known by those skilled in the art, the current flowing in a coil and the magnetic field produced by a coil are in direct proportion. The coil can thus be viewed as a frequency dependent current source. The optimum way to measure this current is with a low impedance amplifier. The amplitude of the current produced by such a coil and amplifier is:

$$I = \frac{ω {BA}_{eff}}{{R}_{i} + {R}_{s} + ω L}$$

### As for the voltage analysis, this current is frequency independent above a frequency given by

$$f = \frac{( {R}_{i} + {R}_{s} )}{2 π L}$$

as was shown for the voltage analysis case. This current is amplified by the circuit shown to produce an output that is frequency independent above the defined circuit dependent frequency value.

As discussed, the construction of sensor 10, including the geometry of coil 65 and the configuration of pre-amplifier 125 influence the bandwidth of the sensor response. Specifically, at low frequency, the response of induction sensor 10 is limited by the filter produced by the inductance of sensor 10 in series with its resistance. For sensor 10 constructed in accordance with the invention, a typical lower frequency 3 dB point is 1-2 Hz, which is ideal for guest screening and conventional security screening applications. The highest frequency of interest in such applications is about 10 Hz, and it is relatively easy to arrange for induction sensor 10 to have an upper frequency roll off at this point by changing the capacitance C₂ of a feedback circuit 130 to pre-amplifier 125 such that

$${f}_{2} = \frac{1}{2 π {R}_{f} {C}_{2}} = 6 - 10 Hz .$$

FIG. 4A also illustrates the manner in which an output of pre-amplifier 125 is preferably sent to a second stage voltage or differential amplifier 150 of amplifier unit 80 to establish an output signal to be analyzed by CPU 96. FIG. 4B illustrates an alternate circuit which has been found to provide better common mode rejection. In addition, FIG. 4C represents a fully differential version of the circuit shown in FIG. 4A. In this design, the coil contains a center tap 155 connected to ground and each half of the coil is measured by a separate amplifier 125, 125′ of corresponding design to that of FIG. 4A. The outputs of amplifiers 125 and 125′ are combined and converted to an output referenced to ground in a differential amplifier 150. In any case, the critical issue is that it is the current flowing in coil 65 that is amplified rather than the voltage produced by the coil.

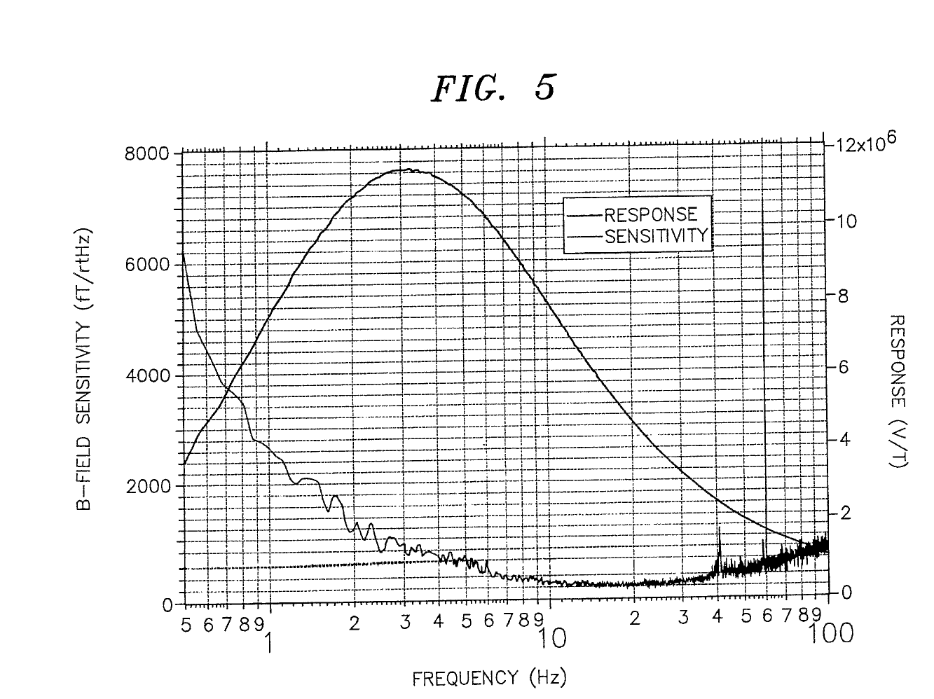

The magnetic field sensitivity and bandpass response of induction sensor 10 designed for security screening applications is shown in FIG. 5. Tailoring the sensitivity of induction sensor 10 in this manner significantly improves resistance to motion noise and immunity to electromagnetic interference. For the sake of completeness, one preferred embodiment of the invention has R_{fb}=R_{fb1}=R_{b2}=50 kOhms; C1=C2=0.47 μF; and f2=6.7 Hz. For a preferred low cutoff frequency using an 18 inch (approximately 45.7 cm) sensor length, R_{dc}=16 Ohm and L_{coil}=1.7 H, then f1=R_{dc}/2πL_{coil}=1.5 Hz.

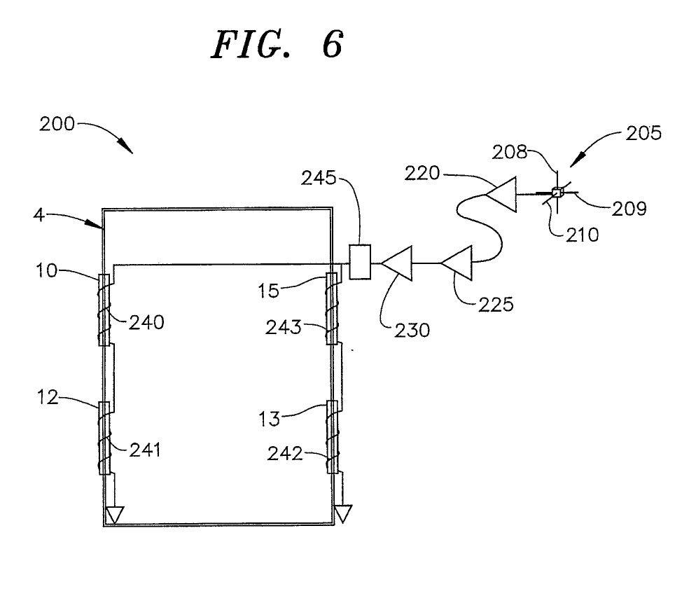

The sensitivity data in FIG. 5 corresponds to the internal noise of sensor 10 and were measured in highly shielded conditions. Even so, significant interference from power line signals at 60 Hz is apparent. To achieve this level of sensitivity, as desired in the practical environments needed for security screening, it is preferable in accordance with the invention to provide active cancellation of external noise that is picked up by sensor 10. To this end, the present invention preferably employs a noise cancellation unit 200 which is schematically represented in FIG. 6. In this embodiment, a remote sensor 205 is located on or adjacent gateway 4, some distance from the locations of primary sensors 10, 12, 13 and 15. Remote sensor 205 is shown to be multi-dimensional, i.e., remote sensor 205 preferably incorporates three orthogonally intersecting sensors 208-210, each of which constitutes a magnetic induction sensor constructed corresponding to any one of sensors 10-19. In any case, remote sensor 205 functions to measure signals from the environment, with the measured signals having minimal contribution from the object or item that system 2 is attempting to detect. This environmental signal is assumed to be substantially common to the total signal measured by each of sensors 10-19 in system 2. The environmental signal from remote sensor 205 is sent to a set of pre-amplifiers 220, the output of which is inverted at 225 and then used as the input to a current source or driver 230, which drives secondary coils, such as secondary coils 240-243.

At this point, it should be noted that, although only one driver 230 is depicted, a separate driver 230 could be employed for each remote sensor 208-210 and each secondary coil 240-243. In any case, each secondary coil 240-243 is wound around a respective one of coils 65 of primary sensors 10, 12, 13 and 15. In series with each secondary coil 240-243 is a gain and phase control device 245 that allows the tuning of the cancellation signal. In this manner, the signals from remote sensor 205 null the environmental signals present in the coils 65 of primary sensors 10, 12, 13 and 15, thereby enabling improved sensitivity. In general, the amplitude of the nulling signal is adjusted to maximally cancel power line (50/60 Hz) interference. Of course, a similar arrangement could be employed for other sensors utilized in the overall system 2, including sensors 11, 14, 16 and 17-19.

By using this analog cancellation method discussed above, the maximum amplitude of the time-varying magnetic signal that must be collected by subsequent electronics is significantly reduced. In addition, the amplitude of general variations in the background signal is reduced in the recorded signal. This rejection of the background fluctuations greatly reduces the false alarm rate of the overall system when screening for small magnetic objects. As an alternative, the output of remote sensor 205 can be digitized and subtracted in a computer, such as CPU 96, by an appropriate algorithm. One such active cancellation method that has been shown to work well with induction sensors 10-19 employs a Wiener filter which adaptively calculates the coefficients that must be applied to the reference sensor output to cancel signals that are common to the reference and measurement sensors. In particularly high noise environments such as operation outdoors, both analog and software cancellation of environmental noise can be utilized.

In accordance with another cancellation arrangement, the coefficients for the adaptive cancellation are calculated using data collected prior to the time system 2 is to be used. A defect of this approach is that, in applications such as security screening, the configuration of the conducting objects in the local environment may change throughout the day as staff change their positions and furniture and other objects are moved. As a result, coefficients that gave adequate cancellation of environmental noise at the beginning of the day may not be sufficient at a later time. One means to address this issue, particularly for security screening, is to collect data for cancellation of environmental noise continuously throughout the day, excluding only those times when a person is passing through gateway 4. Such times can easily be determined by arranging light beam 105, pressure pad 106, or an equivalent sensor in gateway 4 to detect the presence of the subject to be screened, with data collected for a brief predetermined time before and after system 2 is triggered being excluded from the overall cancellation scheme.

A cancellation method to reduce false alarms associated with the subject, i.e., person or object, being screened is to take the difference of the output of any one sensor from the average signal measured by all the signal detection sensors 10-17 of the overall array. For example, a system constructed in this manner has been found to be sufficiently sensitive such that, in conditions when a person carries a high static electric charge, system 2 can detect the magnetic field produced by the effect of this charge moving through gateway 4. This effect produces a signal of almost equal magnitude and phase in all sensors in gateway 4, and can be removed by subtracting the average signal of sensors from the signal of any one sensor.

In another variation, a source of active magnetic field can be added to system 2 thereby creating a magnetic field in a vicinity of the support structure so as to induce eddy currents in metal objects, i.e., a magnetic field response in an item of interest. This arrangement is illustrated in FIG. 1 with the inclusion of a coil 247 in the mat constituting presence sensor 106. Of course, coil 247 could be placed elsewhere, such as about a tube 42 of gateway 4. The direct pickup of the field by sensors 10-19 can be minimized by adding a corresponding cancellation signal to the active nulling signal applied to each sensor. By these means the sensitivity of system 2 can be increased and the discrimination of metal objects of different kinds can be effected by comparing their responses at different frequencies.

As discussed above, system 2 may be combined with a video or still camera 100 to photograph the people or other subjects being screened. The video footage or photographs could be stored in memory 97 in association with its corresponding sensor data and can be analyzed for the purpose of identifying the person or persons responsible for transporting an unauthorized object or item. This additional security measure is considered to be particularly advantageous for law enforcement purposes.

Based on the above, it should be readily apparent that the present invention establishes a magnetic field-based security screening gateway that has the benefit of not emitting any active probing fields, while having high tolerance to environmental electromagnetic noise and noise due to vibration-induced motion of the gateway. Owing to the use of magnetic induction sensors rather than magnetic gradiometers, the width of the opening afforded by the gateway or the spacing between the pillars can be increased considerably over that of prior systems.

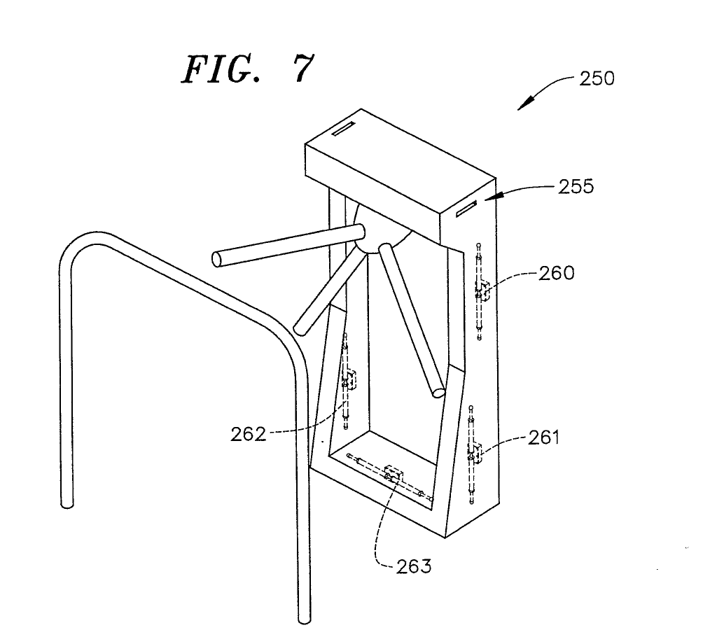

With the above in mind, it should be readily apparent that system 2 can take various forms and be discretely positioned to detect ferrous items unobtrusively. For instance, FIG. 7 illustrates an embodiment wherein a passive magnetic detection system 2 constructed in accordance with the invention is incorporated into a turnstile 250 typically found at the entrance to an amusement park, subway system or the like. Here, a standard ticket collection or scanning device 255 performs a function corresponding to presence sensors 105 and 106. In any case, various magnetic induction sensors, such as sensors 260-263, can be unnoticeably carried by turnstile 250 for detection purposes. This arrangement is just intended to be representative of numerous possible implementations of the invention wherein at least one magnetic induction sensor is rendered visually undetectable in a fixture (support structure) commonly found in its environment, with the sensor performing a security screening of people and other objects passing the support structure. For instance, many other common structures can be modified to incorporate system 2 of the invention in order to screen a desired area, including walls of a causeway, fixed refuse containers, light posts, upstanding poles used to rope off or guide individuals, and other standalone structures, with or without ticket or other validation devices. Signals from a succession of support structure mounted sensors could be used to verify the presence of an unauthorized item prior to issuing a warning, such as on a remote display 98 or even an audible alarm. In addition, other types of sensing devices can be used in combination, such as a biometric identification device or a device to read RF or optical tags.

Further aspects of the invention include the addition of an audio and/or video device mounted at the support structure for communicating messages, such as advertisements, news or instructions, to individuals passing the support structure. This feature of the invention is illustrated with reference to flat screen television 310 shown attached to gateway 4, although such a message communicating arrangement can be advantageously provided in connection with any support structure. In any event, although the invention has been described with reference to preferred embodiments thereof, it should be understood that various changes and/or modifications can be made to the invention without departing from the spirit thereof. In any case, the invention is only intended to be limited by the scope of the following claims.

I/we claim:

1. A magnetic detection system for detecting hidden or otherwise concealed items being taken across a screened zone comprising:
a support structure; and
at least one magnetic induction sensor mounted to said support structure in a defined orientation, said at least one magnetic induction sensor including a primary coil of wire connected to a low impedance amplifier, said at least one magnetic induction sensor being adapted to sense a magnetic field associated with a ferrous item passing the support structure and generate a current in the primary coil of wire, with the current being amplified by the low impedance amplifier such that, over a defined operating bandwidth, the at least one magnetic induction sensor produces an output proportional to the magnetic field.

2. The system according to claim 1, wherein the at least one magnetic induction sensor includes a plurality of magnetic sensors and wherein an output of one of the plurality of magnetic sensors is used to reduce a detection of spurious signals by another one of the plurality of magnetic sensors.

3. The system according to claim 2, further comprising: a cancellation unit including said one of the plurality of magnetic sensors and a secondary coil which is wound on the primary coil of wire, said secondary coil providing a nullifying signal which acts to null signals from a surrounding environmental magnetic field in the primary coil of wire.

4. The system according to claim 1, wherein said at least one magnetic induction sensor has a lower frequency response designed to minimize spurious signals due to low frequency magnetic interference and low frequency motion with respect to a surrounding environmental magnetic field, while enabling signals of interest to be detected.

5. The system according to claim 4, wherein the lower frequency response of the at least one magnetic induction sensor at 3 dB is less than 2 Hz.

6. The system according to claim 1, wherein said at least one magnetic induction sensor is designed with an upper frequency response which is optimized so as to minimize spurious signals due to high frequency magnetic interference and high frequency motion with respect to a surrounding environmental magnetic field, while enabling signals of interest to be detected.

7. The system according to claim 6, wherein the upper frequency response of the at least one magnetic induction sensor at 3 dB is greater than 6 Hz.

8. The system according to claim 1, wherein the at least one magnetic induction sensor includes a plurality of magnetic sensors arranged about the support structure so as to indicate a position of the ferrous item of interest.

9. The system according to claim 8, wherein at least one of the plurality of magnetic sensors is arranged about the support structure in order to detect ferrous items passing around the support structure.

10. The system according to claim 8, wherein at least one of the plurality of magnetic sensors is arranged about the support structure in order to detect a presence of metal in a shoe.

11. The system according to claim 1, wherein the support structure takes the form of a security gateway.

12. The system according to claim 11, further comprising: a presence sensor for verifying a subject at the security gateway.

13. The system according to claim 1, wherein the support structure takes the form of a turnstile.

14. The system according to claim 1, further comprising: a ticket validation device functioning as a presence sensor for verifying a subject of the system.

15. The system according to claim 1, wherein the support structure takes the form of an upstanding pillar.

16. The system according to claim 1, wherein the support structure constitutes a fixture commonly found in its environment and the at least one magnetic induction sensor is visually hidden upon passing the support structure.

17. The system according to claim 1, further comprising: an additional sensor placed near a source of interference for removing interference signals measured by the at least one magnetic induction sensor.

18. The system according to claim 1, further comprising: computer means for acquiring data from the at least one magnetic induction sensor, analyzing and storing the data, and reporting results of a screening process.

19. The system according to claim 1, further comprising: means for capturing images near the support structure.

20. The system according to claim 1, further comprising: means for creating a magnetic field in a vicinity of the support structure so as to induce a magnetic field response in an item of interest.

21. The system according to claim 1, further comprising: an audio and/or video device mounted at the support structure for communicating messages to individuals passing the support structure.

22. A method of detecting hidden or otherwise concealed items being taken across a screened zone comprising:
sensing a magnetic field associated with a ferrous item passing a support structure;
generating a current in a primary coil of a magnetic induction sensor mounted to the support structure in a defined orientation;
amplifying the current with a low impedance amplifier; and
producing an output from the magnetic induction sensor, over a defined operating bandwidth, proportional to the magnetic field.

23. The method of claim 22, further comprising:
sensing a magnetic field from an environment surrounding the screened zone;
developing a nullifying signal based on the magnetic field; and
inducing the nullifying signal to the magnetic induction sensor.

24. The method of claim 22, further comprising:
sensing a presence of a subject to be screened at the support structure; and
compensating for surrounding magnetic fields when the subject is present.

25. The method of claim 22, further comprising: creating a magnetic field in a vicinity of the support structure so as to induce a magnetic field response in the item.
